(19) United States
(12) Patent Application Publication
(10) Pub. No.: US 2011/0071854 A1
(43) Pub. Date: Mar. 24, 2011

(54) HEALTH CARE PAYMENT ESTIMATOR

(75) Inventors: Joe Medeiros, Middletown, CT (US); Christine Marie Riedl, Westmont, IL (US); Rose Anne Pavao, South Glastonbury, CT (US); Bryan Palacio, Glastonbury, CT (US)

(73) Assignee: Aetna Inc., Hartford, CT (US)

(21) Appl. No.: 12/563,911

(22) Filed: Sep. 21, 2009

(51) Int. Cl. G06Q 40/00; G06F 17/30

(52) U.S. Cl. 705/4; 707/769; 707/E17.014

(57) ABSTRACT

To take into account the various specifics of health care information available to the health plan members and health care providers in the context of estimating the members' out-of-pocket payments, embodiments of the invention are used to provide an electronic health care information system with custom interfaces and underlying processing optimized for the health plan member and health care provider contexts. Embodiments of the health care information system construct a pseudo-claim based on the information gathered via the member or provider interfaces and provide an accurate real-time estimate of the member's out-of-pocket responsibility based on adjudicating the pseudo-claim by taking into account the details of the member's health plan and current benefit levels.

### FIELD OF THE INVENTION

This invention relates generally to the field of electronic payment estimation and more specifically to electronically estimating payments in connection with procuring health care services.

### BACKGROUND OF THE INVENTION

With the increasing costs of health care, consumers and health care providers alike are facing formidable challenges in managing the changing economic landscape of health care payments. For consumers, health care remains one area of commerce where most people lack the information necessary to ascertain the cost of rendered services. Yet, it is increasingly likely that a greater number of health care consumers will have a greater portion of their coverage for routine health care exposed to copayments and coinsurance under their health plans. For instance, consumers with High Deductible Health Plans (HDHP) generally enjoy lower premiums in exchange for higher deductibles. Therefore, even routine office visits may lead to considerable expenses affecting the family budget. Likewise, with the increase in health care costs, the expected out-of-pocket amounts for regular health plans are also on the increase, thereby signifying the importance of predictability and transparency of consumer health care expenses ahead of rendered services.

Similarly, the health care providers are likely to face more questions about costs and benefit coverage as consumer out-of-pocket expenses continue to rise. Since consumers typically rate payment of health care expenses among lowest priorities, the health care providers must deal with a higher likelihood of nonpayment with the rise in the amount of outstanding health care consumer debt. This, in turn, leads to increased time and effort required to collect money directly from patients, which further increases the costs of health care. Since the exact details and current state of benefit levels of a consumer's health plan are not typically available to the health care provider, collection of consumer's out-of-pocket portion at the time of the provider visit is typically not feasible.

Therefore, a need exists for providing health plan members and health care providers ways of accurately estimating health care cost allocation, including the health plan member's out-of-pocket responsibility, in advance of providing the desired service or procedure.

### BRIEF SUMMARY OF THE INVENTION

To take into account the various specifics of health care information available to the health plan members and health care providers in the context of estimating the members' out-of-pocket payments, embodiments of the invention are used to provide an electronic health care information system with custom interfaces and underlying processing optimized for the health plan member and health care provider contexts. Embodiments of the health care information system construct a pseudo-claim based on the information gathered via the member or provider interfaces and provide an accurate real-time estimate of the member's out-of-pocket responsibility based on adjudicating the pseudo-claim by taking into account the details of the member's health plan and current benefit levels.

In one aspect of the invention, a method is provided for real-time electronic estimation of out-of-pocket payments by a health plan member for health care services, the method comprising (a) filtering a list of available health care services and procedures based at least in part on user input of one or more of a health plan member's personal information and a health care provider specialty, (b) displaying the filtered list of available health care services for the health plan member via an electronic member interface, (c) receiving an information element selected from the filtered list via the electronic member interface, the information element comprising an indicator of at least one of a medical service and a medical procedure for which a real-time out-of-pocket payment estimate is desired by the health plan member, (d) querying a claims database at the health care claim adjudication computer system to determine zero or more additional related services or procedures typically associated with the health care inquiry string and grouping the services or procedures of the health care inquiry string with the additional related services or procedures based on the determination, (e) compiling a pseudo-claim by matching the medical services or procedures in the grouping with one or more of corresponding procedure codes and corresponding diagnosis codes, (f) forwarding the pseudo-claim to a claim adjudication server for adjudicating the pseudo-claim in real-time based at least in part on contract rates, health plan member's benefit status, and health plan parameters corresponding to the member's health plan, and (g) presenting, via the electronic member interface, the health plan member with the real-time out-of-pocket cost estimate for the desired medical service or procedure.

In another aspect of the invention, a method is provided for real-time electronic estimation of out-of-pocket payments by a health plan member for health care services, the method comprising (a) receiving a health plan member name information for performing an eligibility search for the health plan member by determining the member's active status with the health plan, (b) receiving user input, via an electronic health care provider interface, of one or more of a procedure code, a diagnosis code, a unit charge, a number of units, a provider service charge, a facility charge, and a provider procedure charge corresponding to at least one of a medical service and a medical procedure for which a real-time out-of-pocket payment estimate is desired, (c) compiling a pseudo-claim based on the user input, the user input originating from a health care provider, (d) forwarding the pseudo-claim to a claim adjudication server for adjudicating the pseudo-claim in real-time based at least in part on contract rates, health plan member's benefit status, and health plan parameters corresponding to the member's health plan, and (e) presenting, via the electronic health care provider interface, the health care provider with the real-time out-of-pocket cost estimate for the desired medical service or procedure.

In yet another aspect of the invention, a method is provided for real-time electronic estimation of out-of-pocket payments by a health plan member for health care services, the method comprising (a) receiving user input, via an electronic health care information interface, indicative of at least one of a medical service and a medical procedure for which a real-time out-of-pocket payment estimate is desired, (b) compiling a pseudo-claim based on the user input, (c) forwarding the pseudo-claim to a claim adjudication server for adjudicating the pseudo-claim in real-time based at least in part on contract rates, health plan member's benefit status, and health plan parameters corresponding to the member's health plan, and (d) presenting, via the electronic health care information interface, the user with the real-time out-of-pocket cost estimate for the desired medical service or procedure.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram illustrating an implementation of a system contemplated by an embodiment of the invention with reference to a health care payment estimation system environment;

FIG. 2 is a flowchart illustrating a method of real-time electronic estimation of out-of-pocket payments via information collected from a health plan member, in accordance with an embodiment of the invention;

FIGS. 3-9 are schematic diagrams illustrating an electronic member interface associated with the method of FIG. 2, in accordance with an embodiment of the invention;

FIG. 10 is a flowchart illustrating a method of real-time electronic estimation of out-of-pocket payments via information collected from a health care provider, in accordance with an embodiment of the invention; and

FIGS. 11-15 are schematic diagrams illustrating an electronic provider interface associated with the method of FIG. 10, in accordance with another embodiment of the invention.

### DETAILED DESCRIPTION OF THE INVENTION

The following examples further illustrate the invention but, of course, should not be construed as in any way limiting its scope.

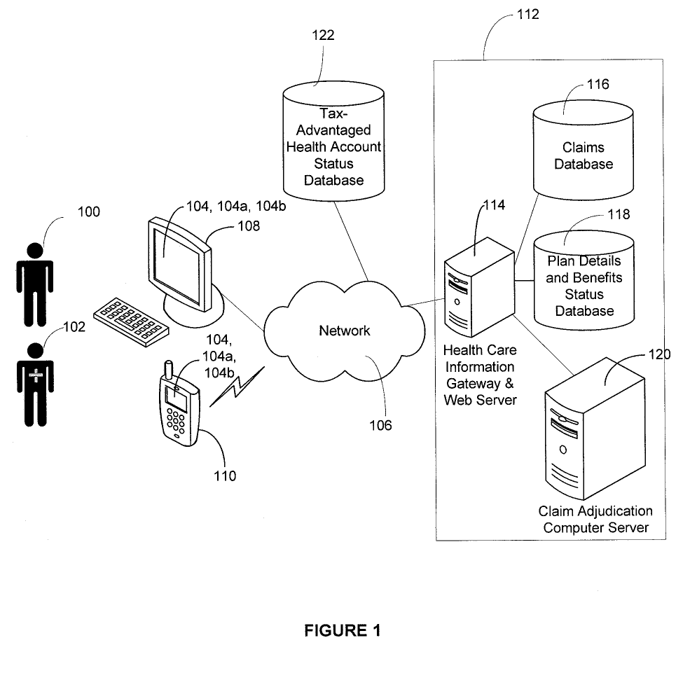

Turning to FIG. 1, an implementation of a system contemplated by an embodiment of the invention is shown with reference to a health care payment estimation system environment. The health plan member 100 and the health care provider 102 connect to their respective versions of an electronic health care information interface 104 for purposes of obtaining a real-time estimate of payment allocation, including the member's out-of-pocket responsibility, for health care services and procedures being procured by the health plan member. Preferably, the electronic health care information interface 104 is an online interface presented to the health plan member 100 and health care provider 102 through a network 106 via wired or wireless computing devices 108, 110, such as desktop or laptop computer stations, as well as mobile computing devices, such as smart phones, PDAs, and the like. In an alternative embodiment, the electronic health care information interface 104 is presented to the users 100, 102 via a secure virtual private network (VPN) connection. The electronic interface 104 comprises computer executable instructions stored in a computer readable medium (e.g., a hard drive, a CD-ROM, or other tangible medium) of one or more computer servers and databases comprising a health care claim adjudication computer system 112. In one embodiment, a health care information gateway and web server 114 stores the computer executable instructions comprising the electronic interface 104. To determine a real-time payment allocation estimate, including a projected out-of-pocket amount, for one or more medical services or procedures desired by the health plan participant 100, the gateway 114 interfaces with a plurality of special-purpose computers and databases optimized for real-time health care payment processing within the claim adjudication computer system 112, such as a health care claims database 116, a health plan detail and member benefits status database 118, and a claim adjudication server 120. In one embodiment, the claim adjudication computer system further interfaces with a tax-advantaged health account status database 122. The tax-advantaged health account database 122 includes up-do-date information on the availability of funds in the health plan member's tax-advantaged health care account, such as a Flexible Spending Account (FSA), a Health Spending Account (HSA), or a Health Reimbursement Account (HRA). Preferably, the claim adjudication computer system 112 is associated with a health plan issuer or administrator in order to gain full access to health plan detail data, as well as real-time updates to the member's 100 benefits status (e.g., by virtue of being tied into a claim adjudication logic). In embodiments, the tax-advantaged health account database is operated by a third-party administrator or directly by the health plan issuer or administrator.

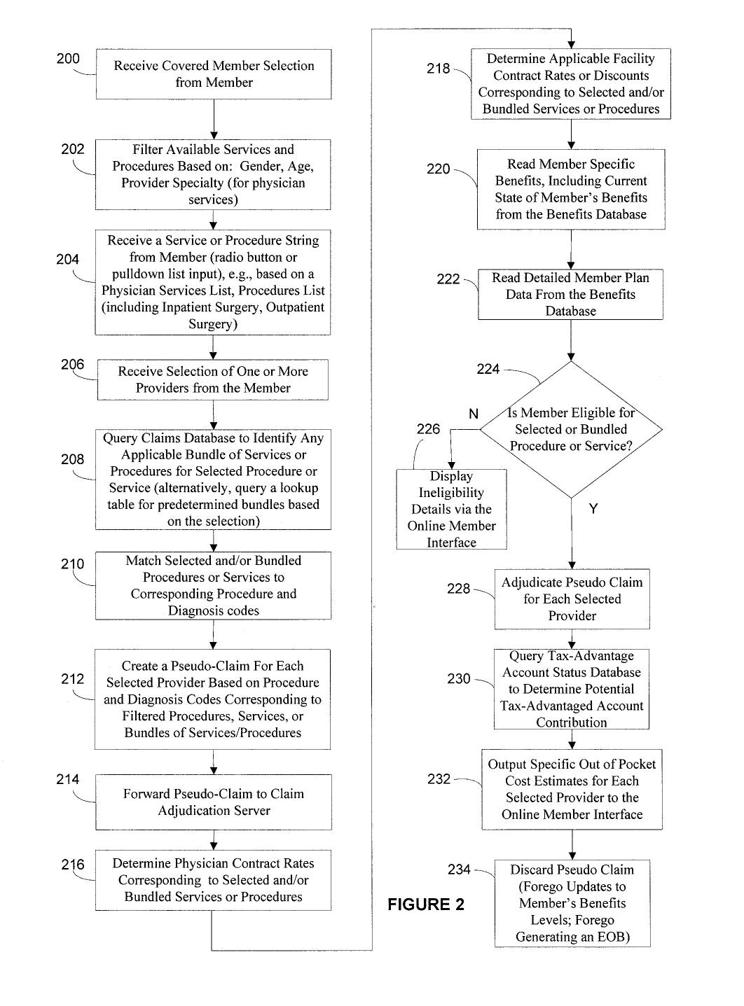

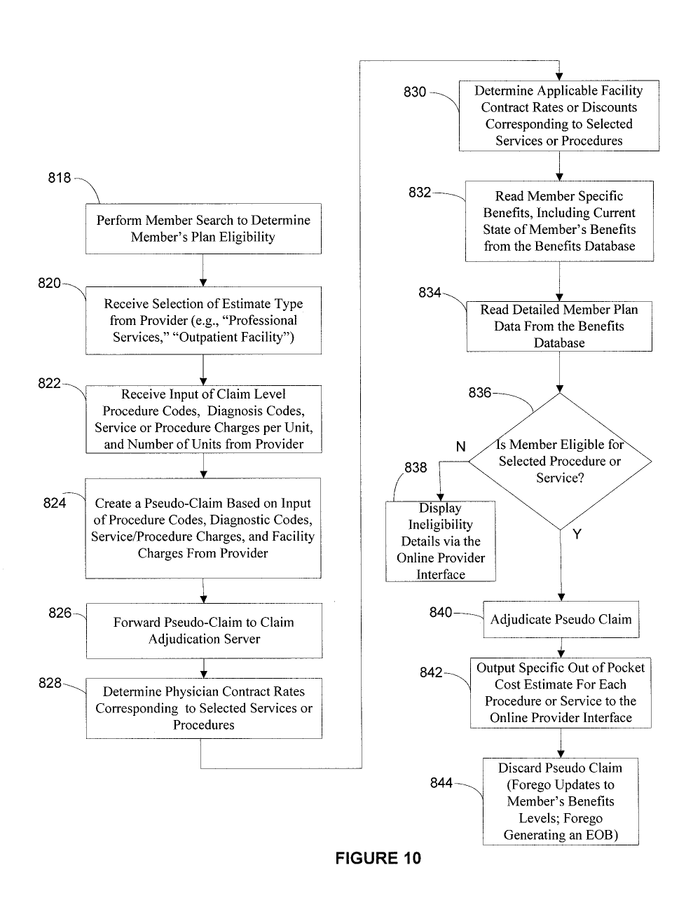

To take into account the various specifics of the information available to the health plan member 100 and a health care provider 102 in the context of estimating the member's out-of-pocket payment, the electronic health care information interface 104 comprises custom interfaces specifically optimized for the health plan member 100 (i.e., the electronic health plan member interface 104a) and the health care provider 102 (i.e., the electronic health care provider interface 104b). To this end, the following discussion is directed to the embodiments of a method of providing an electronic health plan member interface 104a in FIGS. 2-9 below and to a method of providing an electronic health care provider interface 104b in FIGS. 10-15 below.

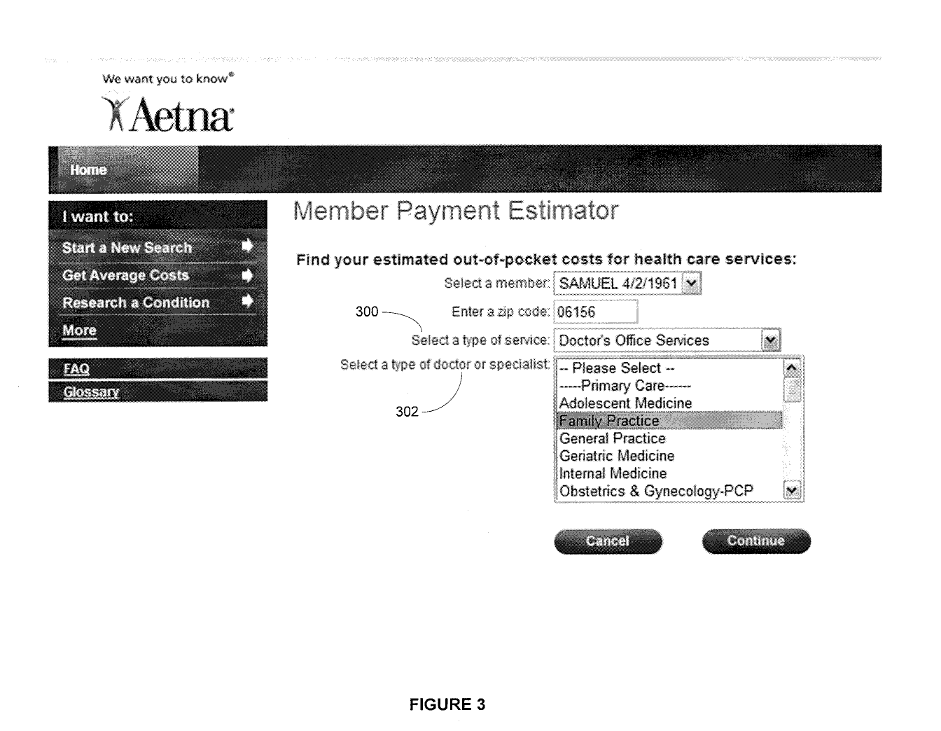

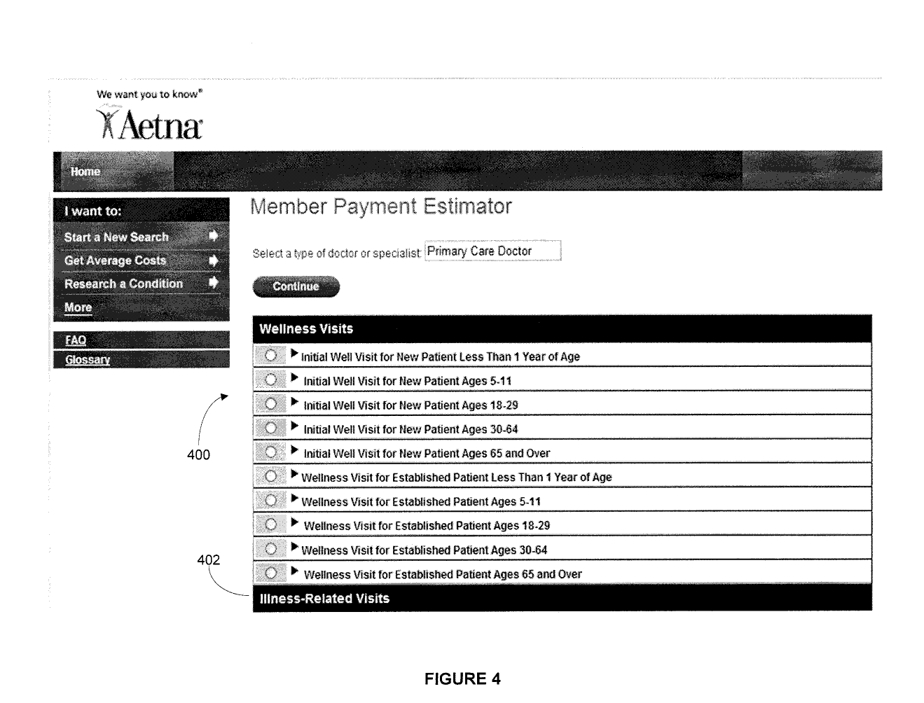

Turning to FIG. 2, an embodiment of a method of real-time electronic estimation of out-of-pocket payments by a health plan member is shown. References to FIGS. 3-9 are made below to further illustrate the embodiments of the electronic member interface 104a associated with the method of FIG. 2. In step 200, the gateway 114 receives selection of a covered health plan participant from the health plan member 100 that is accessing the electronic member interface 104a via a personal login. When the health plan member 100 selects a type of doctor or specialist for the upcoming visit, the gateway 114 filters the services and procedures available for the member's selection based on gender and age of the selected plan member, as well as based on the type of medical service and associated provider specialty selected by the member, step 202. As shown in FIGS. 3-4, the electronic member interface 104a then presents the member with a filtered list of services and procedures based on the foregoing factors. For instance, when the member indicates that he or she is interested in “Doctor's Office Services” 300 from a “Family Practice” 302 (FIG. 3), the member is presented with a customized list of services and procedures, such as various types of “Wellness Visits” 400 and “Illness Visits” 402 (FIG. 4.) available from the selected provider specialty. In another example, the electronic member interface 104a presents the member with a “Well Baby” service selection when the selected health plan member is a newborn or infant. In step 204, the gateway 114 receives an information element (e.g., a character string or the like) indicative of a selection of the service or procedure desired by the member 100 (e.g., a particular type of physician service, a medical procedure, including inpatient or outpatient surgery, or a diagnostic test). In embodiments, the electronic member interface 104a relays the member's selection to the gateway 114 made via a radio button (FIG. 4), a pulldown list, or the like.

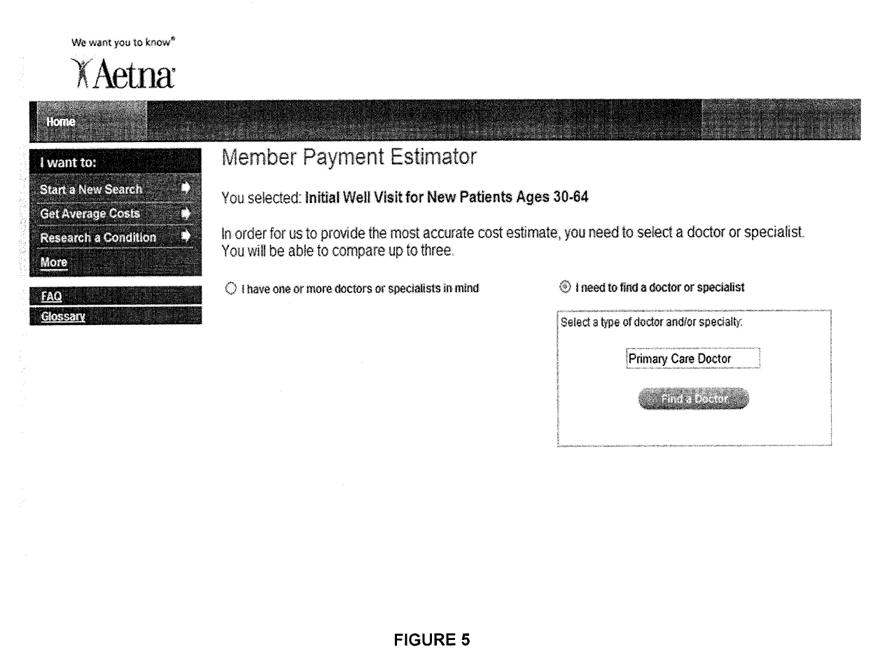

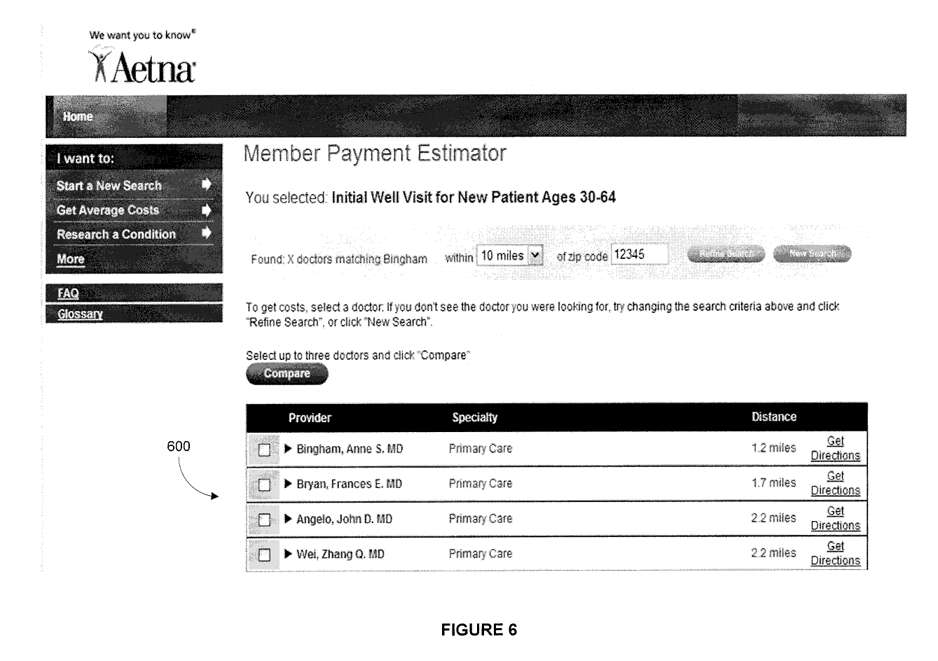

To further enhance the accuracy of the cost estimate, the electronic member interface 100 prompts the member for a selection of a particular doctor or specialist for providing the desired service or procedure. As shown in FIGS. 5-6, the member has the option to either enter a name of an already known health care provider or to perform a provider search based on a distance from a particular zip code location. The search returns multiple health care providers 600 within the specified distance, which the member 100 selects for further price comparison (FIG. 6). In step 206, the gateway 114 receives the member's selection of one or more health care providers for which an out-of-pocket estimate is desired.

To identify any additional services or procedures that are necessarily performed together with the service or procedure selected by the member 100, the gateway 114 queries a claims database 116 and obtains a predetermined list of zero or more additional services or procedures that need to be bundled with the member's selection, step 208. Preferably, the predetermined list of additional services or procedures is correlated with the selected service or procedure based on analysis of claim experience associated with the member's selection. For example, an estimate for a colonoscopy includes the outpatient facility charge, the physician charge and the anesthesiology charges to present the member 100 with the full cost of the procedure. Therefore, the system provides estimates for physician services, facility services, diagnostic tests, and services that include both physician and facility components, such as surgery. For the facility services, the gateway 114 combines all of the typical expenses that are included in the billing (such as units of anesthesia, miscellaneous expenses, and assistant surgeon charges) into the facility cost to provide the member with an overall cost estimate of the total procedure. For services that include both a physician and a facility component, the member is able to select a specific physician and a specific facility in order to obtain an estimate based on particular providers.

In steps 210-212, the gateway 114 builds a pseudo-claim for each provider selected by the member 100 by matching selected and any bundled services or procedures with their corresponding procedure and diagnosis codes. In cases when past claim experience indicates that the selected or bundled services or procedures should also include supplies charges (e.g., based on average usage of a predetermined amount of a particular anesthetic or other medical supplies for a given procedure), such charges are also coded with the bundled charges. The pseudo-claim includes the necessary procedure and diagnosis code information to adjudicate the resulting pseudo-claim request via the claim adjudication logic (i.e., computer executable instructions) stored at the adjudication server 120. Therefore, in step 214, the gateway 114 forwards the resulting pseudo-claim to the claim adjudication server 120 to initiate the real-time claim adjudication process.

Next, in steps 216-218, the adjudication server 120 accesses applicable physician and facility-specific contract rates (or discounts) that have been negotiated by the health plan issuer or administrator for each provider selected by the health plan member. The adjudication server 120 also accesses the plan details and benefits database 118 to read member-specific benefits information, including remaining levels of member's plan year deductible, out-of-pocket plan year maximum, and coinsurance information, step 220. To carry on with the adjudication of the pseudo-claim, the adjudication server further reads the member's health plan parameters from the plan details database 118, step 222. The health plan parameters include the member's active status with the plan, a list of the type of medical services and procedures that are covered and/or excluded from coverage, whether the selected provider is considered in or out-of-network with the member's health plan, existence of applicable limits on the maximum number (or maximum covered dollar amount) of particular type of medical services or procedures that are covered under the plan during the plan year or as a lifetime maximum, member's copayment for physician visits, and the like.

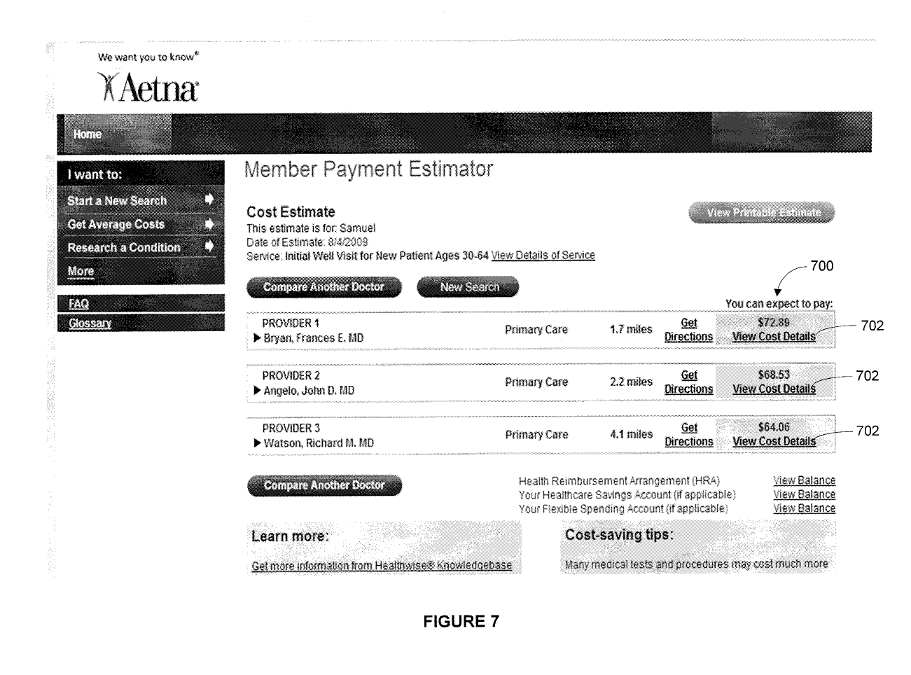

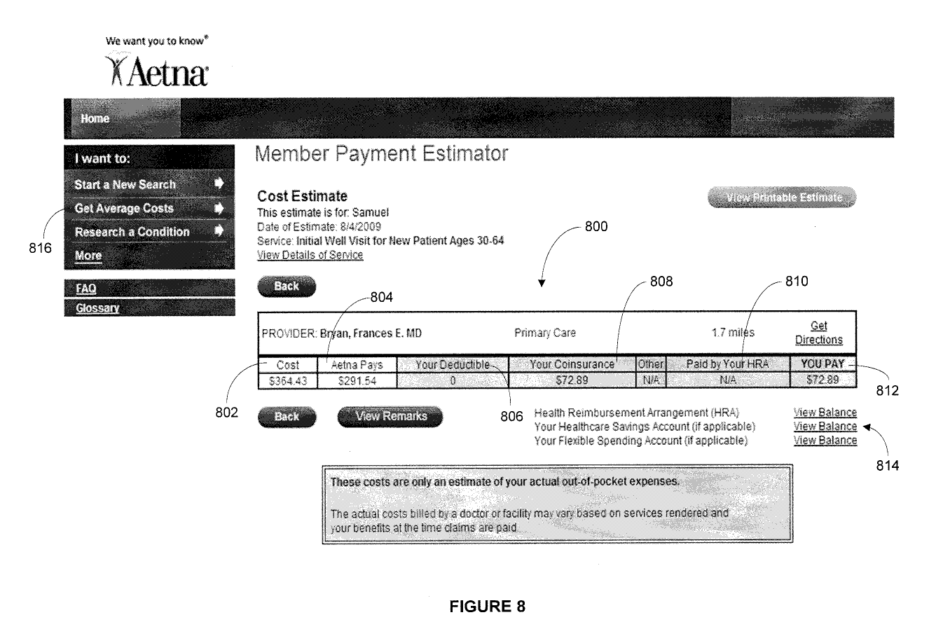

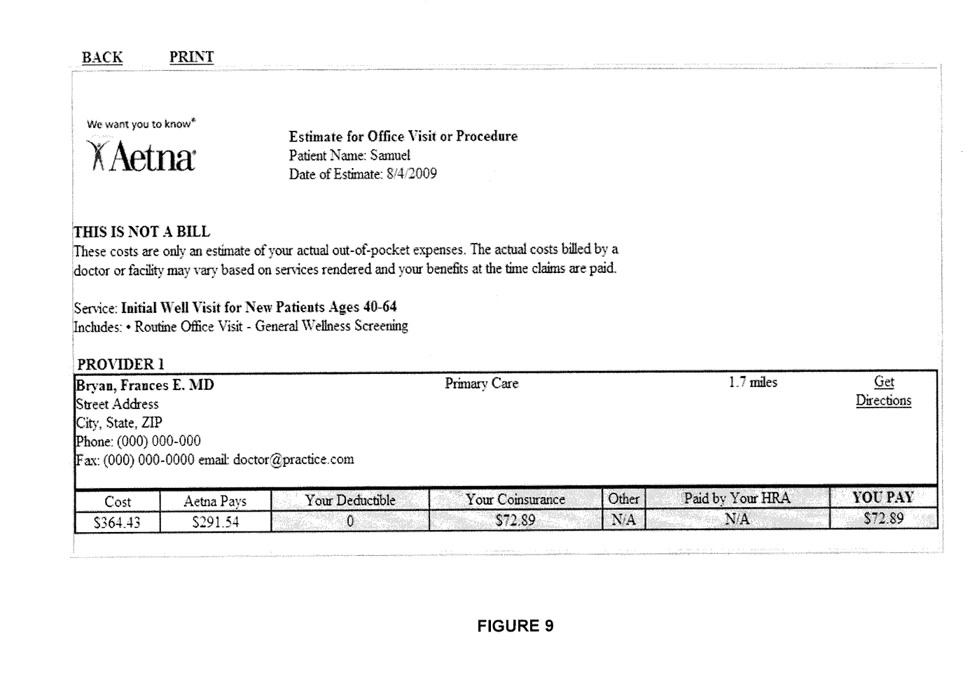

If, in step 224, the adjudication server 120 determines that based on the health plan parameters the member is not eligible for the selected service or procedure (e.g., the member reached the maximum covered number of wellness exams for a given plan year), this information is passed to the gateway 114 for displaying ineligibility details to the member via the electronic member interface 104a, step 226. Otherwise, in step 228, the pseudo-claim is adjudicated via an adjudication engine residing at the adjudication server 120. Preferably, the adjudication server 120 assumes that the health plan issuer is primary (e.g., the member has no other health insurance) and that all required procedure authorizations are in place. As a result, the adjudication server 120 allocates the payment for the selected physician service or medical procedure among the health plan issuer and the member taking into account physician and facility contract rates, any additional services or procedures that need to be bundled with the selected service or procedure, the member's current benefits status, as well as particular health plan details. In one embodiment, the adjudication server 120 (alternatively, the gateway 114) accesses a tax-advantaged health account database 122 to determine availability of contribution toward the member's out-of-pocket amount, step 230. In step 232, the gateway 114 aggregates the payment allocation information determined in the preceding steps and outputs a specific out-of-pocket cost estimate for display via the electronic member interface 104a for each selected provider. As shown in FIG. 7, the electronic member interface 104a presents the member with an expected out-of-pocket amount 700 for each selected health care provider. To view additional detail in connection with the estimate, the member selects the “View Cost Details” link 702 for a particular provider. The cost details link 702 provides the member with a detailed cost estimate 800 (FIG. 8), including procedure cost 802, health plan issuer responsibility amount 804, member's deductible allocation 806, member's coinsurance responsibility 808, any available tax-advantaged health account contribution 810, and the resulting out-of-pocket amount 812 to be contributed by the member. Preferably, the detailed cost estimate screen 800 further includes links 814 to ascertain available balances on one or more of member's tax-advantaged health care accounts. The “Get Average Costs” link 816 allows the member to further compare the claim adjudication-based cost estimate at the selected provider to average historical costs for the same service or procedure. To keep a record of the estimated costs, the member selects the “View Printable Estimate” link 818 to obtain a printer-formatted out-of-pocket estimate (FIG. 9). In step 234, the adjudication server 120 halts the claim-like processing of the pseudo-claim just short of generating a check to the provider and discards the pseudo-claim by foregoing the updates to member's benefits status and foregoing the generation of an Explanation of Benefits (EOB) record for the member.

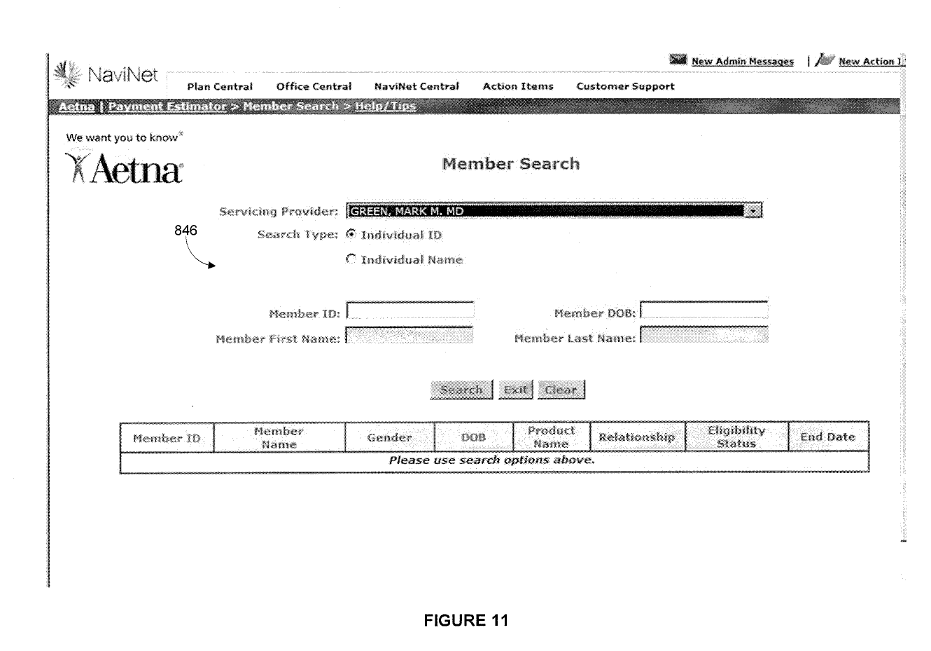

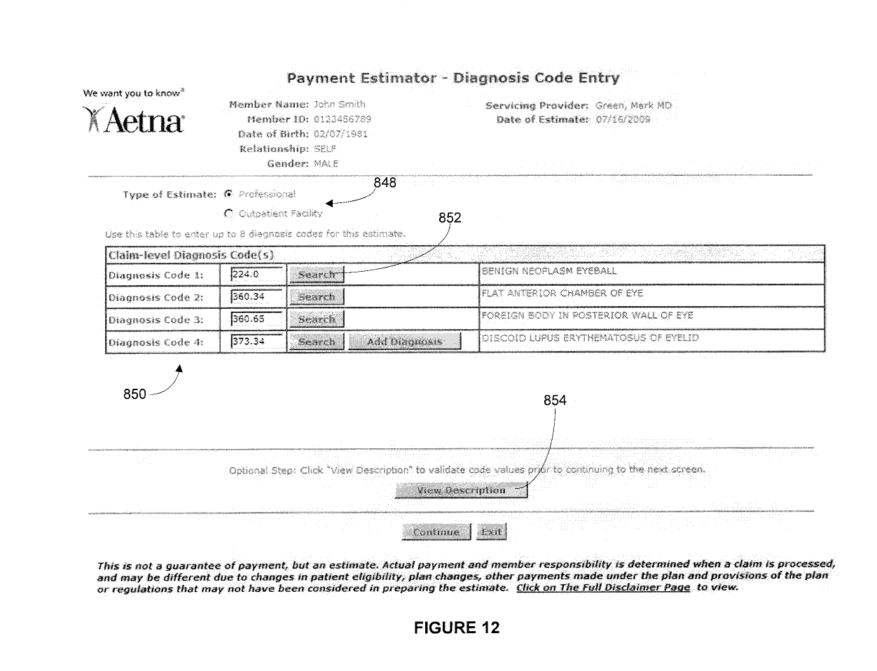

Turning to FIG. 10, another embodiment of a method of real-time electronic estimation of out-of-pocket payments by a health plan member is shown with reference to a health care provider-procured estimate. References to FIGS. 11-15 are made below to further illustrate the embodiments of the electronic health care provider interface 104b associated with the method of FIG. 10. The health care provider 102 may be any clinical or non-clinical personnel associated with medical or health insurance facilities, including nursing, physician, billing, reception, and customer service personnel, for example. In step 818, the health care provider enters the member's health plan identification number or member's name and date of birth information into the member search screen 846 (FIG. 11) to perform a member search and ascertain that the member is actively enrolled with the health plan. Next, in steps 820-822, the gateway 114 receives a selection of the cost estimate type, as well as entries of key claim-level detail including specific procedure codes, diagnosis codes, service or procedure charges per unit, and the projected number of units from the health care provider via the electronic interface 104b. As shown in FIG. 12, in one embodiment, the health care provider selects among a “Professional” and “Outpatient Facility” estimate types 848 and enters specific claim-level detail that is typically known to the provider ahead of the service or procedure visit, including diagnosis codes 850 that are applicable for the service or procedure subject to estimation. In an embodiment, the estimate types 848 further include inpatient procedures.

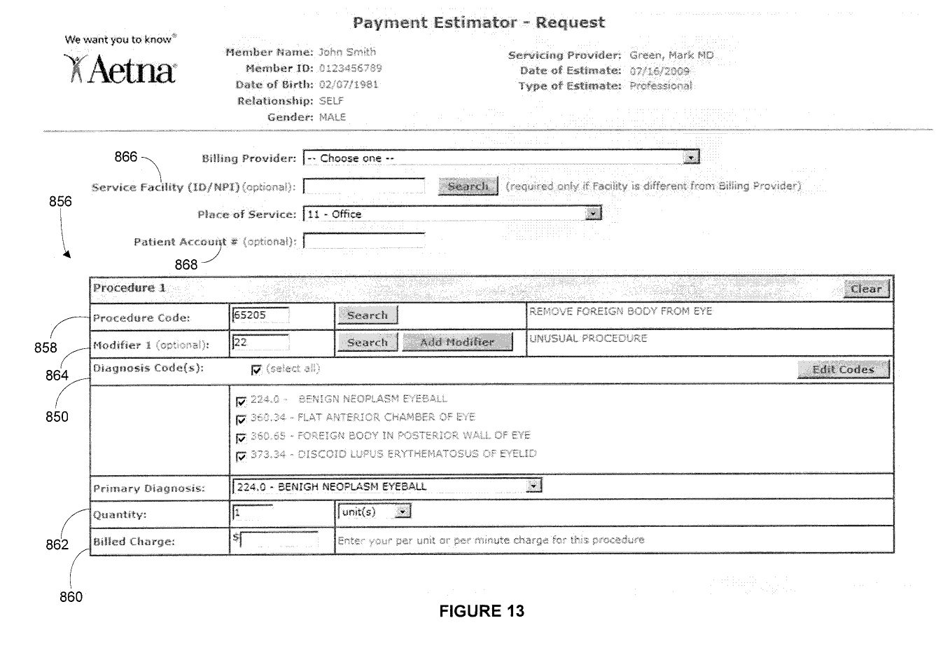

To validate proper entry of diagnosis code numbers, the health care provider selects a “search” option 852 to retrieve the corresponding textual description via the electronic health care provider interface 104b. For instance, diagnosis code 224.0 corresponds to a “Benign Neoplasm Eyeball” diagnosis. Alternatively, to validate all entered codes at once, the health care provider selects a “View Description” option 854. Subsequent to diagnosis code validation, the health care provider is presented with a request interface 856 (FIG. 13), where key claim-level data entry is continued by supplying the procedure code 858 corresponding to the previously entered diagnosis codes (e.g., procedure code “65205”—“Remove Foreign Body From Eye” corresponds to the entry of primary diagnosis code “224.0”—“Benign Neoplasm Eyeball”). As further shown in FIG. 13, the health care provider further enters a per unit charge 860 associated with the current procedure (e.g., a per minute charge), a number of units 862 (e.g., minutes, hours) that the procedure or service is expected to consume, as well as optional details like a procedure type modifier 864 (e.g., modifier “22” corresponding to an “Unusual Procedure” for billing purposes), associated service facility identification number 866, and patient account number 868, if known.

Referring again to FIG. 10, in steps 824-826, the gateway 114 builds a pseudo-claim based on the foregoing information entered by the health care provider via the electronic provider interface 104b and forwards the constructed pseudo-claim to the adjudication server 120. Next, in steps 828-830, the adjudication server 120 accesses applicable physician and facility-specific contract rates (or discounts) that have been negotiated by the health plan issuer for a particular service or procedure selected by the health plan member. The adjudication server 120 also accesses the plan details and benefits database 118 to read member-specific benefits information, including remaining levels of member's plan year deductible, out-of-pocket plan year maximum, and coinsurance information, step 832. To continue with the adjudication of the pseudo-claim, the adjudication server reads the member's health plan parameters from the plan details database 118, step 834. The health plan parameters include the member's active status with the plan, a list of the type of medical services and procedures that are covered and/or excluded from coverage, whether the selected provider is considered in or out-of-network with the member's health plan, existence of applicable limits on the maximum number (or maximum covered dollar amount) of particular type of medical services or procedures that are covered under the plan during the plan year or as a lifetime maximum, member's copayment for physician visits, and the like.

If, in step 836, the adjudication server 120 determines that based on the health plan parameters the member is not eligible for the selected service or procedure, this information is passed to the gateway 114 for displaying ineligibility details to the provider via the electronic provider interface 104b, step 838. Otherwise, in step 840, the pseudo-claim is adjudicated via an adjudication engine residing at the adjudication server 120. Preferably, the adjudication server 120 assumes that the health plan issuer is primary (e.g., the member has no other health insurance) and that all required procedure authorizations are in place. The adjudication server then allocates the payment for the entered physician service or procedure among the health plan issuer and the member taking into account the provider's fee schedule (e.g., via input of procedure or service charge/units), physician and facility contract rates for the procedure and/or diagnosis codes entered by the health care provider, the member's current benefits status, as well as the member's health plan details. Optionally, the adjudication server 120 (alternatively, the gateway 114) also accesses a tax-advantaged health account database 122 to determine availability of contribution toward the member's out-of-pocket amount. In step 842, the gateway 114 aggregates the payment allocation information determined in the preceding steps and outputs a specific out-of-pocket cost estimate for display to the provider via the electronic health care provider interface 104b.

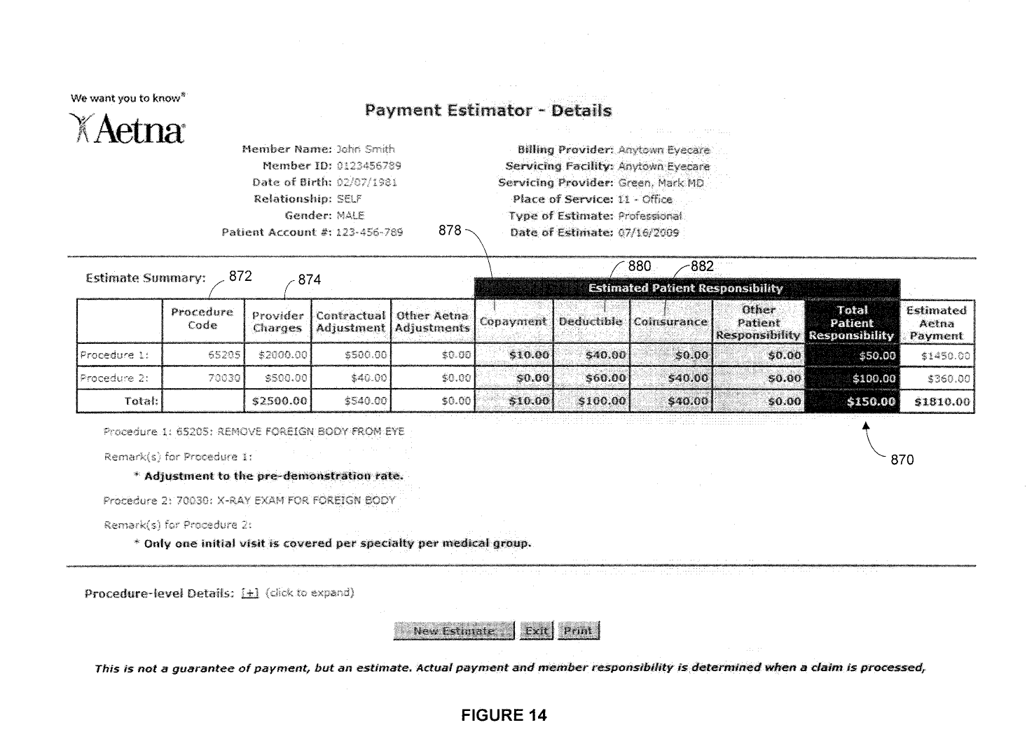

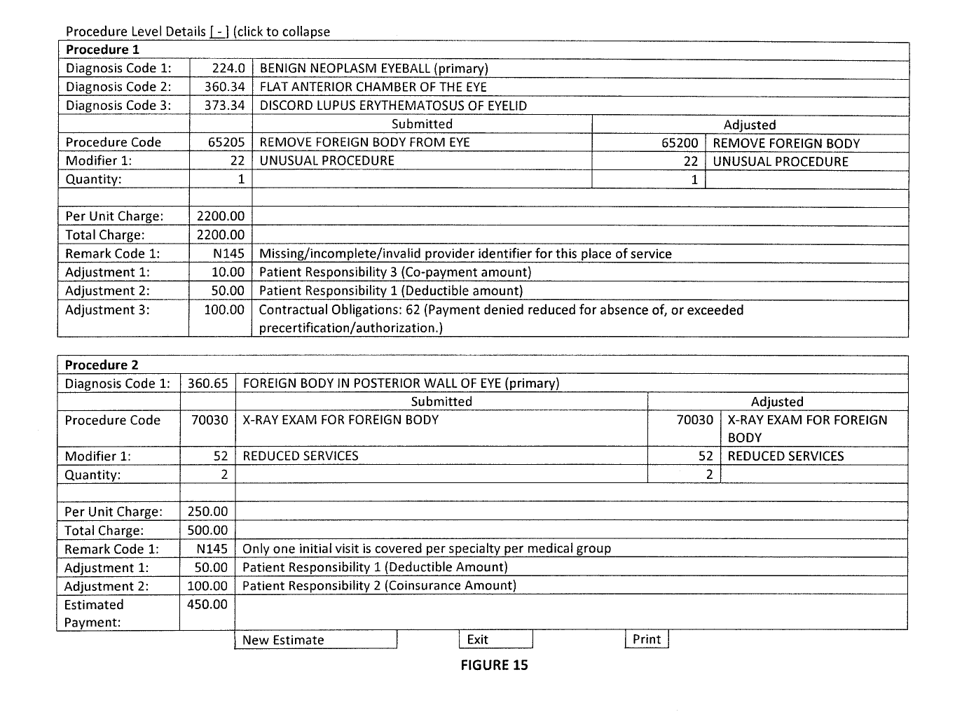

As shown in FIG. 14, the electronic health care provider interface 104b presents the provider with an expected patient total responsibility amount 870 for each service or procedure entered by the health care provider. The health care provider is presented with a detailed cost estimate that further includes a procedure code 872, the corresponding provider charge 874, the contractual adjustment amount 876 to the provider charge per member's health plan, as well as the underlying member responsibility amounts in terms of a copayment 878, a deductible portion 880, and a coinsurance portion 882 of the member's total responsibility 870. The estimate further includes an amount of payment due to the health care provider from the health plan issuer. In an embodiment, the estimate further presents the health care provider with procedure remarks, such as warnings with respect to the maximum number of covered visits per specialty, and the like. Preferably, the electronic provider interface 104b presents an option to the provider for viewing procedure-level detail for each estimated procedure, as shown in FIG. 15. Referring again to FIG. 10, in step 844, the adjudication server 120 halts the claim-like processing of the pseudo-claim short of generating a check to the provider and discards the pseudo-claim by foregoing the updates to member's benefits status and the generation of an Explanation of Benefits (EOB) record for the member.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. In a health care claim adjudication computer system, a method of real-time electronic estimation of out-of-pocket payments by a health plan member for health care services, the method comprising:
filtering a list of available health care services and procedures based at least in part on user input of one or more of a health plan member's personal information and a health care provider specialty;
displaying the filtered list of available health care services for the health plan member via an electronic member interface;
receiving an information element selected from the filtered list via the electronic member interface, the information element comprising an indicator of at least one of a medical service and a medical procedure for which a real-time out-of-pocket payment estimate is desired by the health plan member;
querying a claims database at the health care claim adjudication computer system to determine zero or more additional related services or procedures typically associated with the information element and grouping the at least one service or procedure of the information element with the additional related services or procedures based on the determination;
compiling a pseudo-claim by matching the medical services or procedures in the grouping with one or more of corresponding procedure codes and corresponding diagnosis codes;
forwarding the pseudo-claim to a claim adjudication server for adjudicating the pseudo-claim in real-time based at least in part on contract rates, health plan member's benefit status, and health plan parameters corresponding to the member's health plan; and
presenting, via the electronic member interface, the health plan member with the real-time out-of-pocket cost estimate for the desired medical service or procedure.

2. The method of claim 1 further comprising receiving a selection of multiple health care providers from the health plan member via the electronic member interface and presenting the health plan member with an out-of-pocket estimate for each of the selected health care providers.

3. The method of claim 1 wherein the electronic member interface is an online interface.

4. The method of claim 1 wherein the contract rates are selected from the group consisting of: physician contract rates corresponding to the medical services or procedures in the pseudo-claim, and facility contract rates associated with the medical services or procedures in the pseudo-claim.

5. The method of claim 1 further comprising determining the health plan member's eligibility for the medical services or procedures in the pseudo-claim based on the member's health plan parameters.

6. The method of claim 5 wherein the health plan parameters are selected from the group consisting of: the health plan member's active status with the health plan, medical services and procedures covered in the health plan, health care provider's in-network status in accordance with the health plan, and a limit on a number of covered medical services or procedures during a predetermined time period.

7. The method of claim 1 further comprising querying a tax-advantaged health care account database to determine availability of contribution to the health plan member's out-of-pocket estimate.

8. The method of claim 1 further comprising discarding the pseudo-claim by foregoing one or more of updating the member's health plan benefit status and generating an Explanation Of Benefits (EOB) record.

9-23. (canceled)

24. A health care claim adjudication computer system for real-time electronic estimation of out-of-pocket payments by a health plan member for health care services, the system comprising:
a health care information gateway configured for filtering a list of available health care services and procedures based at least in part on user input of one or more of a health plan member's personal information and a health care provider specialty;
an electronic member interface configured for displaying the filtered list of available health care services for the health plan member;
the health care information gateway further configured for receiving an information element selected from the filtered list via the electronic member interface, the information element comprising an indicator of at least one of a medical service and a medical procedure for which a real-time out-of-pocket payment estimate is desired by the health plan member;
a claims database connected to the health care information gateway, the claims database configured for determining zero or more additional related services or procedures typically associated with the information element, the health care information gateway grouping the at least one service or procedure of the information element with the additional related services or procedures based on the determination and compiling a pseudo-claim by matching the medical services or procedures in the grouping with one or more of corresponding procedure codes and corresponding diagnosis codes; and
a claim adjudication server configured for adjudicating the pseudo-claim in real-time based at least in part on contract rates, health plan member's benefit status, and health plan parameters corresponding to the member's health plan, the claim adjudication server generating the real-time out-of-pocket estimate for the desired medical service or procedure for presenting to the health plan member via the electronic member interface.

25. The health care claim adjudication computer system of claim 24 wherein the electronic member interface is an online interface.

26. The health care claim adjudication computer system of claim 24 wherein the contract rates are selected from the group consisting of: physician contract rates corresponding to the medical services or procedures in the pseudo-claim, and facility contract rates associated with the medical services or procedures in the pseudo-claim.

27. The health care claim adjudication computer system of claim 24 wherein the claim adjudication server determines the health plan member's eligibility for the medical services or procedures in the pseudo-claim based on the member's health plan parameters.

28. The health care claim adjudication computer system of claim 27 wherein the health plan parameters are selected from the group consisting of: the health plan member's active status with the health plan, medical services and procedures covered in the health plan, health care provider's in-network status in accordance with the health plan, and a limit on a number of covered medical services or procedures during a predetermined time period.

29. The health care claim adjudication computer system of claim 24 wherein the claim adjudication server discards processing the pseudo-claim by foregoing one or more of updating the member's health plan benefit status and generating an Explanation Of Benefits (EOB) record.

30. In a health care claim adjudication computer system, a computer readable medium having stored thereon computer executable instructions for real-time electronic estimation of out-of-pocket payments by a health plan member for health care services, the instructions comprising:
filtering a list of available health care services and procedures based at least in part on user input of one or more of a health plan member's personal information and a health care provider specialty;
displaying the filtered list of available health care services for the health plan member via an electronic member interface;
receiving an information element selected from the filtered list via the electronic member interface, the information element comprising an indicator of at least one of a medical service and a medical procedure for which a real-time out-of-pocket payment estimate is desired by the health plan member;
querying a claims database at the health care claim adjudication computer system to determine zero or more additional related services or procedures typically associated with the information element and grouping the at least one service or procedure of the information element with the additional related services or procedures based on the determination;
compiling a pseudo-claim by matching the medical services or procedures in the grouping with one or more of corresponding procedure codes and corresponding diagnosis codes;
forwarding the pseudo-claim to a claim adjudication server for adjudicating the pseudo-claim in real-time based at least in part on contract rates, health plan member's benefit status, and health plan parameters corresponding to the member's health plan; and
presenting, via the electronic member interface, the health plan member with the real-time out-of-pocket cost estimate for the desired medical service or procedure.

31. The computer readable medium of claim 30 wherein the instructions further comprise receiving a selection of multiple health care providers from the health plan member via the electronic member interface and presenting the health plan member with an out-of-pocket estimate for each of the selected health care providers.

32. The computer readable medium of claim 30 wherein the electronic member interface is an online interface.

33. The computer readable medium of claim 30 wherein the contract rates are selected from the group consisting of: physician contract rates corresponding to the medical services or procedures in the pseudo-claim, and facility contract rates associated with the medical services or procedures in the pseudo-claim.

34. The computer readable medium of claim 30 wherein the instructions further comprise determining the health plan member's eligibility for the medical services or procedures in the pseudo-claim based on the member's health plan parameters.

35. The computer readable medium of claim 34 wherein the health plan parameters are selected from the group consisting of: the health plan member's active status with the health plan, medical services and procedures covered in the health plan, health care provider's in-network status in accordance with the health plan, and a limit on a number of covered medical services or procedures during a predetermined time period.

36. The computer readable medium of claim 30 wherein the instructions further comprise querying a tax-advantaged health care account database to determine availability of contribution to the health plan member's out-of-pocket estimate.

37. The computer readable medium of claim 30 wherein the instructions further comprise discarding the pseudo-claim by foregoing one or more of updating the member's health plan benefit status and generating an Explanation Of Benefits (EOB) record.
